(19) United States
(12) Patent Application Publication
(10) Pub. No.: US 2005/0271876 A1
(43) Pub. Date: Dec. 8, 2005

(54) Method for producing carbon-carbon brake material with improved initial friction coefficient or 'bite'

(76) Inventors: Terrence B. Walker, South Bend, IN (US); Darrell L. Johnson, South Bend, IN (US)

Correspondence Address: Larry J. Palguta;Honeywell Law Department, 3520 Westmoor Street, South Bend, IN, 46628, US

(21) Appl. No.: 10/861,991

(22) Filed: Jun. 4, 2004

(51) Int. Cl. C01B 31/02; B32B 9/00

(52) U.S. Cl. 428/408; 264/29.1; 264/29.5

(57) ABSTRACT

Method of manufacturing a brake pad that has improved initial friction coefficient or “bite”. The method involves molding a carbon-carbon preform into the desired shape; carbonizing the preform by gradually heating it to 650-900° C. and holding it at that temperature for approximately one hour, heating the carbonized preform at 1950-2050° C. for approximately 4 hours, infiltrating the preform with colloidal silica to fill pores in the preform matrix with silicon carbide, heating the silica-containing preform at about 1800° C. for approximately 4 hours to convert the silica to silicon carbide, subjecting the preform to Carbon Vapor Deposition (CVD) for from 500-1000 hours, and heating the preform at 1600-2800° C. for approximately 4 hours to produce the brake pad material.

### FIELD OF THE INVENTION

This invention relates to improvements in the compositions and methods of manufacture of carbon-carbon composite friction materials, and especially to improvements in the performance of such materials in vehicular braking systems.

### BACKGROUND OF THE INVENTION

Due to the increased brake performance requirements for newer aircraft and the unique physical, thermal, and chemical properties of carbon-based material, carbon-carbon brake friction materials have gained wide acceptance on both commercial and military aircraft. The heat capacity, thermal conductivity, high temperature strength, and density make carbon an ideal material for the demanding conditions which often occur during aircraft landings.

Another area in which the excellent performance characteristics provided by carbon-carbon composite brake materials is appreciated is in the field of high performance automobiles, such as those used in Formula I racing.

In the manufacture of brake friction components, carbon-carbon composites are produced by molding a blank (or “preform”) from a molding compound that comprises, for instance, pitch-based carbon fibers coated with phenolic resin. Typically, a random fiber matrix of carbon fibers coated with a carbonizable resin is molded, and the resin is carbonized. After carbonization, the preform is heat treated. The conventional temperature for post-carbonization heat treatment is 2175° C. This heat treatment increases the modulus and stabilizes the carbon fiber. The preform is then densified using a resin impregnation process and/or Chemical Vapor Infiltration (CVI). CVI entails introducing a carbon-containing precursor gas into a furnace where decomposition of the gas results in the deposition of elemental carbon in porous areas within the fiber/textile matrix. Typical densification cycles are hundreds of hours long in multiple cycles. Generally, these carbon-carbon composite preforms are subjected to a final post-densification heat treatment. Alternatively, a fibrous matrix may be built up from carbon-fiber textile materials and densified by CVI. CARBENIX® 2000 series carbon-carbon composites are typical of materials made from random fiber preforms. CARBENIX® 4000 series carbon-carbon composites are typical of materials made from textile material based preforms. CARBENIX® brand carbon-carbon composites are produced by Honeywell International.

### SUMMARY OF THE INVENTION

High initial friction coefficient, or “bite”, is a desirable property in Formula I racing friction brake materials. High bite, or instantaneous initial friction coefficient, provides the race driver with an increased feeling of control. Conversely, low initial friction coefficient may be desirable in some applications where “grabbiness” is undesirable. The present invention provides a means for adjusting the bite characteristics of carbon-carbon composite materials that will be used to make brake pads.

Bite is believed to be related to the rate of temperature rise and temperature distribution in the interface between the brake pad and the brake rotor, with higher temperatures at the interface resulting in improved bite. It has been found that in-plane thermal conductivity of the pad material influences bite, and that, surprisingly, conducting the post-carbonization heat treatment at temperatures lower than the conventional temperature, for instance, at 2000° C., significantly improves initial friction coefficient (“bite”). Brake pads manufactured in accordance with this invention also have significantly improved wear properties.

This invention provides a method of making an automobile brake pad from random fiber carbon-carbon composites, which method includes the steps of molding a brake pad blank from a molding compound that comprises pitch-based carbon fibers coated with phenolic resin, carbonizing the coated fibers to form a carbonized matrix, heat-treating the carbonized matrix, and densifying the heat-treated carbonized matrix. An important feature of this embodiment of the invention involves carrying out the post-carbonization heat treatment at a temperature in the range 1950° C. through 2050° C., preferably at 2000° C.

Another aspect of the present invention is the brake pad products produced by this process. The improved bite which characterizes the brake pad products of this invention may be realized, for instance, when the novel brake pads are used for braking in combination with a carbon-carbon rotor comprising textile preform derived carbon-carbon composites, such as CARBENIX® 4000 series materials. Initial friction coefficients in the range of 0.47 through 0.5 may be obtained when the novel brake pads of this invention are used in combination with a CARBENIX® 4000 series carbon-carbon rotor.

In a broader aspect, the present invention provides a method for adjusting the initial coefficient of friction in a pitch-derived carbon fiber-based carbon-carbon composite, which method comprises conducting the initial heat treatment step at a temperature in the range of 1800-2600° C. When the initial heat treatment step is conducted at a temperature in the range of 1950-2050° C., as described above, this method imparts improved bite to the carbon-carbon composite being manufactured. When the initial heat treatment step is conducted at a temperature in the range of 2500-2600° C., this method imparts reduced “grabbiness” to the carbon-carbon composite being manufactured.

### DETAILED DESCRIPTION OF THE INVENTION

The method of manufacturing a brake pad in accordance with this invention includes the steps of: (a) molding a random carbon fiber preform or a densified carbon textile preform into the desired shape; (b) carbonizing the brake preform by gradually heating it to a temperature in the range of 650-900° C. and holding it at that temperature for approximately one hour; (c) heating the carbonized preform at a temperature in the range 1950-2050° C. for approximately 4 hours; (d) infiltrating the preform with colloidal silica to fill pores in the preform matrix with silicon carbide; (e) heating the silica-containing preform at a temperature of about 1800° C. for approximately 4 hours to convert the silica to silicon carbide; (f) subjecting the preform to Carbon Vapor Deposition (CVD) for from 500-1000 hours; and (g) heating the brake pad preform at a temperature of 1600-2800° C. for approximately 4 hours to produce the brake pad material.

Molding a random carbon fiber preform or a densified carbon textile preform into the desired shape. The desired shape in this step would be a brake pad or another shape such as an annulus or block. Those skilled in the art are fully conversant with apparatus layouts and techniques for molding fibrous matrices into brake pad preforms and the like. U.S. Pat. No. 5,888,645, the entire disclosure of which is hereby expressly incorporated by reference, provides just one example of a disclosure of molding a brake pad preform.

Carbonizing the brake preform by gradually heating it to a temperature in the range of 650-900° C. and holding it at that temperature for approximately one hour. The carbonization of carbon-carbon composite materials is well known to those skilled in the art.

Heating the carbonized preform at a temperature in the range 1950-2050° C. for approximately 4 hours. This post-carbonization heat treatment step is the crux of the present invention. As will be seen from the Examples which follow, it has been surprisingly discovered that the temperature employed in this step has a profound effect on the initial coefficient of friction of brake pad materials manufactured in accordance with the overall process described herein. A variant of the present invention provides for reducing “grabbiness” in a carbon-carbon composite brake pad by conducting this initial heat treatment step at a temperature in the range of 2500-2600° C.

Infiltrating the preform with colloidal silica to fill pores in the preform matrix with silicon carbide. In a typical colloidal infiltration process, preform open pore volume is measured using standard butanol absorption tests. Given a desired volume of weight-% additive, commercial colloidal materials, such as LUDOX® AS-40 or AS-44 available from DuPont, are diluted so that the amount of additive contained in the measured open pore volume is equal to the desired volume-% based on the total volume of the preform. Full details on silica infiltration may be found in U.S. Pat. No. 5,962,135, the entire disclosure of which is hereby expressly incorporated by reference.

Heating the silica-containing preform at a temperature of about 1800° C. for approximately 4 hours to convert the silica to silicon carbide. This step serves to “set” the silicon carbide within the fibrous matrix of the preform, and additionally drives off any volatiles remaining from the infiltration process.

Subjecting the preform to Carbon Vapor Deposition (CVD) for from 500-1000 hours. Those skilled in the art are fully conversant with apparatus layouts and techniques for CVD procedures as applied to brake preforms. U.S. Pat. No. 5,900,297, the entire disclosure of which is hereby expressly incorporated by reference, provides just one example of a disclosure of CVD processing.

Heating the brake pad preform at a temperature of 1600-2800° C. for approximately 4 hours to produce the brake pad material. This final heat treatment step produces the desired crystal structure in the carbon (or graphite) of the brake pad preform or annulus or block.

At various stages of the above processing, the brake disc preforms are removed from the molding and CVI/CVD apparatuses and surface-ground. This grinding is done to reopen surface pore channels blocked by, e.g., the CVI/CVD processing. After grinding, the partially densified preforms are returned to the processing apparatus to undergo the next stage of treatment.

Those skilled in the art of manufacturing carbon-carbon composites will recognize that the benefits of the present invention may be obtained with variations in the temperatures and times mentioned above. For instance, the carbonization step may, depending upon such factors as the thickness of the preform being carbonized and the precise temperature employed, be carried out for a longer or shorter period than one hour. Likewise, based upon similar considerations, the post-carbonization heat treatment may be carried out for longer or shorter period than four hours, as may be the silica conversion step and the final heat treatment step. The silica conversion step, of course, can be carried out at temperatures above or below 1800° C., so long as a temperature is employed that will convert silica to silicon carbide within a reasonable time period.

### EXAMPLES

Improved Bite:

A random fiber matrix of pitch-based carbon fibers coated with phenolic resin was molded in the shape of a brake pad and then carbonized. Subsequently, the carbonized brake pad preform was heated at 2000° C. for 4 hours. The composite was then ground to a thickness of 1.034 inches. The weight of the undensified preform at this point was 5136 grams. The composite was subsequently subjected to infiltration with colloidal silica (LUDOX®, AS-44) at a dilution level sufficient to achieve a final volume-% silicon carbide of 0.5%, and dried. The brake pad preform was then heated at 1800° C. for 4 hours, after which it was subjected to Carbon Vapor Deposition (CVD) for 750 hours. The weight of the composite at this point was approximately 6612 grams. Finally, a third heat treatment was carried out at 1800° C. for 4 hours, and manufacture of the brake pad material was completed by grinding it to a thickness of 0.902 inches.

Automotive brake pads cut from the processed discs were tested in an automotive brake dynamometer using a carbon-carbon brake rotor made from Honeywell CARBENIX® 4000 series carbon-carbon composite. Testing consisted of a 450 km test, including approximately 725 braking efforts. Decelerations were of two types: 1) 340 km/hr to 125 km/hr and 2) 220 km/hr to 145 km/hr. For the first 150 km the average initial coefficient of friction value (“bite”) was 0.47. The average coefficient of friction value for the entire 450 km was 0.45.

Conventional:

A random fiber matrix of pitch-based carbon fibers coated with phenolic resin was molded in the shape of an annulus and then carbonized. Subsequently, the carbonized brake preform was heated at 2175° C. for 4 hours. The preform composite was then ground to a thickness of 1.034 inches. The weight of the molded preform at this point was 5219 grams. The composite was subsequently subjected to infiltration with colloidal silica (LUDOX®, AS-44) at a dilution level sufficient to achieve a final volume-% silicon carbide of 0.5%, and dried. The brake pad preform was then heated at 1800° C. for 4 hours, after which it was subjected to CVD for 750 hours. The weight of the composite at this point was approximately 6958 grams. Finally, a third heat treatment was carried out at 1800° C. for 4 hours, and manufacture of the brake pad material was completed by grinding it to a thickness of 0.902 inches.

Automotive brake pads cut from the processed discs were tested in an automotive brake dynamometer using a carbon-carbon brake rotor made from Honeywell CARBENIX® 4000 series carbon-carbon composite. Testing consisted of a 450 km test, including approximately 725 braking efforts. Decelerations were of two types: 1) 340 km/hr to 125 km/hr and 2) 220 km/hr to 145 km/hr. For the first 150 km the average initial coefficient of friction value (“bite”) was only 0.45. The average coefficient of friction value for the entire 450 km was 0.42.

Reduced Grabbiness:

A random fiber matrix of pitch-based carbon fibers coated with phenolic resin was molded in the shape of a brake pad and then carbonized. Subsequently, the carbonized brake pad preform was heated at 2540° C. for 4 hours. The preform composite was then ground to a thickness of 1.034 inches. The weight of the molded preform at this point was 5136 grams. The composite was subsequently subjected to infiltration with colloidal silica (LUDOX®, AS-44) at a dilution level sufficient to achieve a final volume-% silicon carbide of 0.5%, and dried. The brake pad preform was then heated at 1800° C. for 4 hours, after which it was subjected to CVD for 750 hours. Finally, a third heat treatment was carried out at 1800° C. for 4 hours, and manufacture of the brake pad material was completed by grinding it to a thickness of 0.902 inches.

Automotive brake pads cut from the processed discs were tested in an automotive brake dynamometer using a carbon-carbon brake rotor made from Honeywell CARBENIX® 4000 series carbon-carbon composite. Testing consisted of a 450 km test, including approximately 725 braking efforts. Decelerations were of two types: 1) 340 km/hr to 125 km/hr and 2) 220 km/hr to 145 km/hr. For the first 25 braking efforts, the average initial friction value was less than 0.4. Due to the low values, testing was suspended.

1. In a method of making an automobile brake pad from random fiber carbon-carbon composites comprising the steps of molding a brake pad blank from a molding compound that comprises pitch-based carbon fibers coated with phenolic resin, carbonizing the coated fibers to form a carbonized matrix, heat-treating the carbonized matrix, and densifying the heat-treated carbonized matrix, the improvement which comprises carrying out the post-carbonization heat treatment at a temperature in the range 1950° C. through 2050° C.

2. The method of claim 1, wherein said post-carbonization heat treatment is carried out at a temperature of 2000° C.

3. The product of the process of claim 1.

4. The automotive brake pad of claim 3, in combination with a carbon-carbon rotor comprising a random fiber carbon-carbon composite material.

5. The automotive brake pad of claim 3, having an initial friction coefficient, when used in combination with a CARBENIX® 4000 series carbon-carbon rotor, in the range of 0.47 through 0.5.

6. The automotive brake pad of claim 5, having an initial friction coefficient of 0.47.

7. A method of manufacturing a brake pad that has an initial coefficient of friction greater than 0.45, which method comprises the steps of:
(a) molding a random carbon fiber preform or a densified carbon textile preform into the desired shape;
(b) carbonizing the brake preform by gradually heating it to a temperature in the range of 650-900° C. and holding it at that temperature for approximately one hour;
(c) heating the carbonized preform at a temperature in the range 1950-2050° C. for approximately 4 hours;
(d) infiltrating the preform with colloidal silica to fill pores in the preform matrix with silicon carbide;
(e) heating the silica-containing preform at a temperature of about 1800° C. for approximately 4 hours to convert the silica to silicon carbide;
(f) subjecting the preform to Carbon Vapor Deposition (CVD) for from 500-1000 hours; and
(g) heating the brake pad preform at a temperature of 1600-2800° C. for approximately 4 hours to produce the brake pad material.

8. A method for adjusting the initial coefficient of friction in a pitch-derived carbon fiber-based carbon-carbon composite, which method comprises conducting the initial heat treatment step at a temperature in the range of 1800-2600° C.

9. The method of claim 8, wherein improved bite is imparted to said carbon-carbon composite by conducting the initial heat treatment step at a temperature in the range of 1950-2050° C.

10. The method of claim 8, wherein reduced grabbiness is imparted to said carbon-carbon composite by conducting the initial heat treatment step at a temperature in the range of 2500-2600° C.
